(19) United States
(12) Patent Application Publication
(10) Pub. No.: US 2026/0228935 A1
(43) Pub. Date: Aug. 6, 2026

(54) DISPLAY CONTROL DEVICE

(71) Applicant: TOYOTA JIDOSHA KABUSHIKI KAISHA, Toyota-shi (JP)

(72) Inventor: Arata TAKADA, Toyota-shi (JP)

(73) Assignee: TOYOTA JIDOSHA KABUSHIKI KAISHA, Toyota-shi (JP)

(21) Appl. No.: 19/422,769

(22) Filed: Dec. 17, 2025

(30) Foreign Application Priority Data
Jan. 31, 2025 (JP) 2025-015642

(51) Int. Cl. G06T 11/00; G06T 7/246; G06T 7/73; G06V 20/20; G06V 20/58

(52) U.S. Cl. CPC G06T 11/00; G06T 7/248; G06T 7/74; G06V 20/20; G06V 20/584; G06T 2207/30204; G06T 2207/30256; G06T 2207/30261; G06T 2210/21

(57) ABSTRACT

A display control device includes an object marker detection unit configured to detect an object marker with a predetermined sensor provided in a host vehicle, an object marker estimation unit configured to estimate a superimposition state of an object marker on a front side and within a detection range of the sensor and an object marker on a back side, and a display controller configured to, when estimation is made that the object marker on the back side is present overlapping the object marker on the front side in the superimposition state, make an image corresponding to the object marker on the front side transparent and cause an image corresponding to the object marker on the back side to be displayed with the image corresponding to the object marker on the back side virtually superimposed onto the image corresponding to the object marker on the front side.

### CROSS-REFERENCE TO RELATED APPLICATION

This application claims priority to Japanese Patent Application No. 2025-015642 filed on January 31, 2025. The disclosure of the above-identified application, including the specification, drawings, and claims, is incorporated by reference herein in its entirety.

### BACKGROUND

### Technical Field

The present disclosure relates to a display control device.

### Description of Related Art

Japanese Unexamined Patent Application Publication No. 2017-054311 (JP 2017-054311 A) discloses an object detection device that can more accurately determine a type of an object by using a captured image. In JP 2017-054311 A, a captured image obtained by imaging a traveling direction of a host vehicle is subjected to image processing to detect a pedestrian or a motorcycle as an object present around the host vehicle. The type of the object is temporarily determined by analyzing the captured image, and the temporarily determined type of the object is definitively determined by using a movement speed of the object.

### SUMMARY

In addition, in the related art, for example, a technology of displaying an object marker as presence information of an object detected by a sensor on a display device with an icon is known. However, in a case where multiple object markers overlap each other within a detection range of a camera, the display of the object marker present behind the object markers is not assumed. Further, in a case where the object marker is not displayed due to the overlap, there is a possibility that a user’s attention to the object marker decreases.

An object of the present disclosure is to provide a display control device that can ensure visibility in display of superimposed object markers.

A display control device according to a first aspect includes: an object marker detection unit configured to detect an object marker with a sensor that is predetermined, the sensor being provided in a host vehicle; an object marker estimation unit configured to estimate a superimposition state of an object marker on a front side present in front of the host vehicle and within a detection range of the sensor and an object marker on a back side present behind the object marker on the front side; and a display controller configured to, in a case where estimation is made that the object marker on the back side is present overlapping the object marker on the front side in the superimposition state, make an image corresponding to the object marker on the front side transparent and cause an image corresponding to the object marker on the back side to be displayed with the image corresponding to the object marker on the back side virtually superimposed onto the image corresponding to the object marker on the front side.

The display control device according to the first aspect is configured to display the object marker not within the detection range in a superimposed manner. As a result, visibility of the object marker that is on the back side and is no longer detectable can be ensured, and the user can pay attention to the presence of the object marker.

With the display control device according to a second aspect, in the display control device according to the first aspect, the object marker detection unit is configured to assign a status including a traveling direction of the detected object marker, the object marker estimation unit is configured to estimate, in the assigned status, in a case where estimation is made that the object marker to be estimated is traveling in a direction intersecting a traveling direction of the host vehicle and disappears from the detection range in a vicinity of the object marker on the front side as the object marker to be estimated travels, the superimposition state by using the object marker to be estimated as the object marker on the back side, and the display controller is configured to cause, in a case where the object marker on the back side in the superimposition state disappears from the detection range as the object marker on the back side travels, the image corresponding to the object marker on the back side to be displayed with the image corresponding to the object marker on the back side virtually superimposed onto the image corresponding to the object marker on the front side. With the display control device according to the second aspect, visibility of the object marker corresponding to the pedestrian or the motorcycle that is on the back side and is no longer detectable can be ensured.

With the display control device according to a third aspect, in the display control device according to the first aspect or the second aspect, the object marker detection unit is configured to assign a status including a traveling direction and a lane of the detected object marker, the object marker estimation unit is configured to estimate, in the assigned status, in a case where estimation is made that an object marker on an outer side of an object marker on an adjacent lane to a traveling lane of the host vehicle is traveling in a front-rear direction and disappears from the detection range in a vicinity of the object marker on the adjacent lane, the superimposition state by using the object marker on the adjacent lane as the object marker on the front side and using the object marker on the outer side as the object marker on the back side, and the display controller is configured to cause, in a case where the object marker on the back side in the superimposition state disappears from the detection range as the object marker on the back side travels, the image corresponding to the object marker on the back side to be displayed with the image corresponding to the object marker on the back side virtually superimposed onto the image corresponding to the object marker on the front side. With the display control device according to the third aspect, visibility of the object marker corresponding to an ordinary vehicle or an automatic motorcycle that is on the back side and is no longer detectable can be ensured.

With the display control device according to a fourth aspect, in the display control device according to the second aspect or the third aspect, the status includes a movement speed, and the display controller is configured to adjust, in accordance with the movement speed before the estimated object marker on the back side disappears from the detection range, a superimposition position on the image corresponding to the object marker on the front side. With the display control device according to the fourth aspect, it is possible to reduce a sense of discomfort in a case where the object markers are displayed in a superimposed manner.

With the display control device according to a fifth aspect, in the display control device according to the first aspect, the object marker estimation unit is configured to estimate, for the object marker on the back side that has disappeared from the detection range at an intersection, movement information including a movement start timing and a movement speed of the object marker on the back side in accordance with signal switching of a traffic light at the intersection, and the display controller is configured to cause the image corresponding to the object marker on the back side to be displayed by moving the image in accordance with the estimated movement information. With the display control device according to the fifth aspect, it is possible to reduce a sense of discomfort of the display of the object markers superimposed at the intersection.

According to the technology of the present disclosure, it is possible to ensure the visibility in the display of the superimposed object markers.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of an in-vehicle system according to the present embodiment;

FIG. 2 is a schematic diagram showing a relationship between an object marker on a front side and an object marker on a back side in a detection range;

FIG. 3 is an example of a case where there are a plurality of object markers on the back side;

FIG. 4 is an example of a case where the object marker on the front side and the object marker on the back side have the same type of object marker of an ordinary vehicle;

FIG. 5 is a flowchart for describing a flow of display control processing as a display control method executed by display control of the present embodiment; and

FIG. 6 is an example of detection and display of the object marker on the back side in a case where there is an intersection and a traffic light.

### DETAILED DESCRIPTION OF EMBODIMENTS

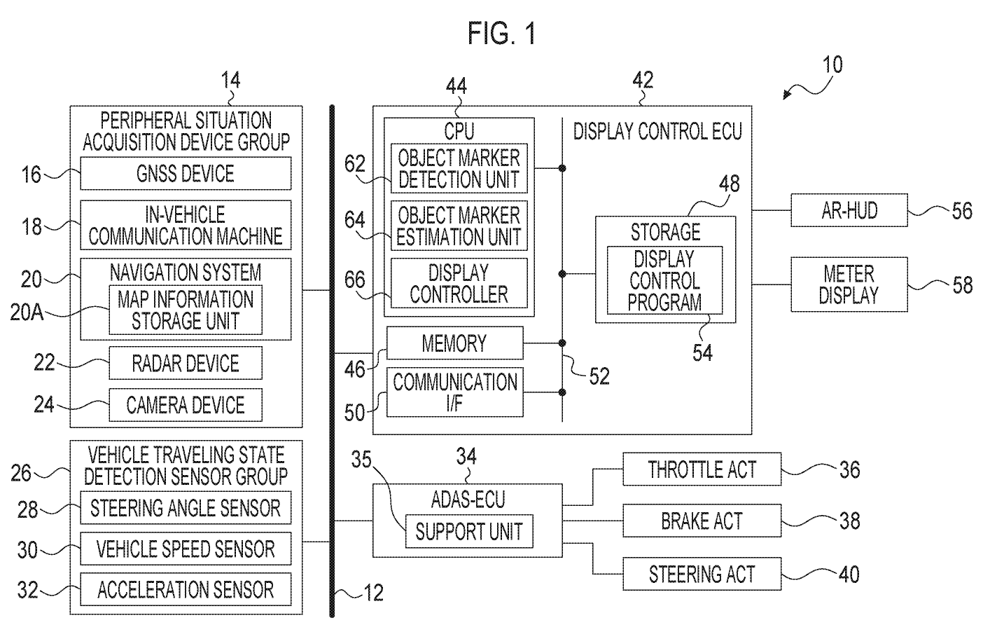

Hereinafter, an example of an embodiment of the present disclosure will be described in detail with reference to the drawings. As shown in FIG. 1, an in-vehicle system 10 according to the present embodiment comprises a communication bus 12. A peripheral situation acquisition device group 14, a vehicle traveling state detection sensor group 26, an advanced driver-assistance systems (ADAS)-ECU 34, and a display control ECU 42 are each connected to the communication bus 12. FIG. 1 shows solely a part of the in-vehicle system 10. In addition, hereinafter, a vehicle equipped with the in-vehicle system 10 is referred to as a host vehicle.

The peripheral situation acquisition device group 14 includes a global navigation satellite system (GNSS) device 16, an in-vehicle communication machine 18, a navigation system 20, a camera device 24, a radar device 22, and the like as devices that acquire peripheral information indicating what kind of situation a peripheral environment of the host vehicle is in.

The GNSS device 16 receives a GNSS signal from a plurality of GNSS satellites to determine a position of the host vehicle. The in-vehicle communication machine 18 performs at least one of vehicle-to-vehicle communication with another vehicle or road-to-vehicle communication with a roadside machine. The navigation system 20 includes a map information storage unit 20A that stores map information, and performs processing of displaying the position of the host vehicle on a map or determining a route to a destination and guiding the host vehicle to the destination based on the position information obtained from the GNSS device 16 and the map information stored in the map information storage unit 20A.

The radar device 22 is a radar group that detects an object, such as another vehicle or a pedestrian, present around the host vehicle as point cloud information, and detects an object present in front, sides, and behind of the host vehicle. In addition, the radar device 22 acquires a relative position and a relative speed between the detected object and the host vehicle. In the display control ECU 42 described below, the presence of the object marker is detected from the detection result of the radar device 22.

In addition, the radar device 22 excludes noise or a roadside object such as a guardrail from a monitoring target object based on a change in the relative position or the relative speed with each object, and outputs information such as the relative position or the relative speed with the object marker that is a monitoring target object such as another vehicle or a pedestrian.

The camera device 24 is a plurality of cameras that image the periphery of the host vehicle, and outputs the captured images. In the present embodiment, a case where the camera device 24 images the front of the host vehicle is described as an example, but a side camera that images a side of the host vehicle at a close distance from a side camera and a side mirror that image an area behind the host vehicle can also be assumed. In the display control ECU 42 described below, the object marker and a type of the object marker are identified from information on an object present within the captured image. The camera device 24 is an example of a sensor according to the present disclosure.

As described above, the detection result of the radar device 22 can be used to detect that an object is present. However, the object marker itself and the type of the object marker are detected by analyzing the image of the camera device 24. In a case where an object marker (object marker on the front side) that blocks the detection range of the camera is detected and another object marker (object marker on the back side) is present behind the object marker, the other object marker present behind the object marker is out of the detection range. Therefore, in the present embodiment, the object marker on the back side is displayed by being virtually superimposed on the object marker on the front side.

The vehicle traveling state detection sensor group 26 includes a steering angle sensor 28 that detects a steering angle of the host vehicle, a vehicle speed sensor 30 that detects a traveling speed of the host vehicle, and an acceleration sensor 32 that detects an acceleration applied to the host vehicle, as a plurality of sensors that acquire a traveling state of the host vehicle.

A throttle ACT 36 that changes a throttle opening degree of the host vehicle, a brake ACT 38 that changes a braking force generated by a braking device of the host vehicle, and a steering ACT 40 that changes a steering amount of a steering device of the host vehicle are each connected to the ADAS-ECU 34.

Although not shown, the ADAS-ECU 34 includes a CPU, a memory such as a ROM or a RAM, a storage such as an HDD or an SSD, and a communication interface (I/F). The storage stores a predetermined program for causing the CPU of the ADAS-ECU 34 to function as a support unit 35. In a case where the host vehicle is in a driving assistance mode, the support unit 35 performs support processing of controlling the throttle ACT 36, the brake ACT 38, and the steering ACT 40 to support at least one of acceleration/deceleration or steering of the host vehicle based on information obtained from the peripheral situation acquisition device group 14 and the vehicle traveling state detection sensor group 26, a detection result of the object marker by the display control ECU 42, and the like. An example of a driving assistance function implemented by the support processing includes Adaptive Cruise Control (ACC) that causes the host vehicle to travel by following a lead vehicle traveling in a lane, and Lane Keeping Assist (LKA) that assists steering such that the host vehicle travels in the center of the lane.

### First Embodiment

The display control ECU 42 includes a CPU 44, a memory 46 such as a ROM or a RAM, a storage 48 such as an HDD or an SSD, and a communication I/F 50. The CPU 44, the memory 46, the storage 48, and the communication I/F 50 are connected to each other via an internal bus 52 such that they can communicate with each other. The storage 48 stores a display control program 54. In the display control ECU 42, the display control program 54 is read out from the storage 48 and loaded into the memory 46, and the display control program 54 loaded into the memory 46 is executed by the CPU 44. The CPU 44 functions as an object marker detection unit 62, an object marker estimation unit 64, and a display controller 66, and performs display control processing described below. The function as the object marker detection unit 62 may be an external function of the display control ECU 42, or an object marker detection ECU may be separately provided.

An augmented reality (AR)-head-up display (hereinafter, referred to as an AR-HUD) 56 and a meter display 58 are connected to the display control ECU 42. The AR-HUD 56 according to the present embodiment is a small HUD in which a part of a front visual field of an occupant of the host vehicle is set as a display region (an image is formed in a lower foreground) by reflection on a windshield glass or the like. In addition, the meter display 58 is a display provided in an instrument panel of the host vehicle. The display control ECU 42 controls the information display on the AR-HUD 56 and the meter display 58. The display control ECU 42 is an example of a display control device according to the present disclosure, and the AR-HUD 56 and the meter display 58 are examples of a display unit in the present disclosure.

The object marker detection unit 62 detects the presence of an object around the host vehicle from the detection result of the radar device 22. In addition, the object marker detection unit 62 detects an object marker from an image captured by the camera device 24 by collating the detected object with the image. In addition, in the detection of the object marker, a type of the object marker is identified. In the present embodiment, as the type of the object marker, at least an ordinary vehicle (including a passenger vehicle and a commercial vehicle from a small size to a large size, such as a truck in the present embodiment), an automatic motorcycle, a bicycle, and a pedestrian are identified.

Here, the object marker detection unit 62 assigns a status that is a base for estimation of movement information to the detected object marker. The status is assigned with a movement speed, a traveling location, a traveling direction, and a size for each type of the object marker. For example, in a case of the pedestrian, the status is assigned as “pedestrian → movement speed: slow, traveling location: sidewalk, traveling direction: front/rear/right/left, size: small”. In a case of the bicycle, the status is assigned as “bicycle → movement speed: medium, traveling location: sidewalk (or a road side belt of a vehicle), traveling direction: front/rear/right/left, size: medium”. In a case of the automatic motorcycle, the status is assigned as “automatic motorcycle → movement speed: fast, traveling location: road, traveling direction: front/rear, size: medium”. In a case of the ordinary vehicle, the status is assigned as “ordinary vehicle → movement speed: fast, traveling location: road, traveling direction: front/rear, size: large”. In addition, information on a lane is also assigned to the traveling location of the automatic motorcycle and the ordinary vehicle, and a lane adjacent to a traveling lane of the host vehicle is also identified.

The object marker estimation unit 64 estimates a superimposition state of the object marker on the front side present within the detection range and the object marker on the back side, for the object marker detected by the object marker detection unit 62. The object marker on the back side is an object marker that is estimated to be present overlapping the back side of the object marker on the front side. Here, the front side refers to being located on a side close to the host vehicle on the front side in a detectable range from an imaging range (detection range) that is a viewpoint of the camera device 24 of the host vehicle. The back side refers to being located on a side behind the host vehicle than a position of the object marker on the front side, with the position of the object marker on the front side as a reference. For the object marker on the back side, the object marker on the front side may be an obstacle, and the detectability of the object marker may be reversed depending on a positional relationship between the imaging range and the object marker on the front side.

In a case where it is estimated that the object marker on the back side is present overlapping the object marker on the front side in the superimposition state, the display controller 66 displays an image corresponding to the object marker on the back side by making an image corresponding to the object marker on the front side transparent and virtually superimposing the image corresponding to the object marker on the back side on the image corresponding to the object marker on the front side. Here, the transparent display control may be control of making an entirety of the object marker on the front side transparent or may be control of making the object marker on the front side partially transparent.

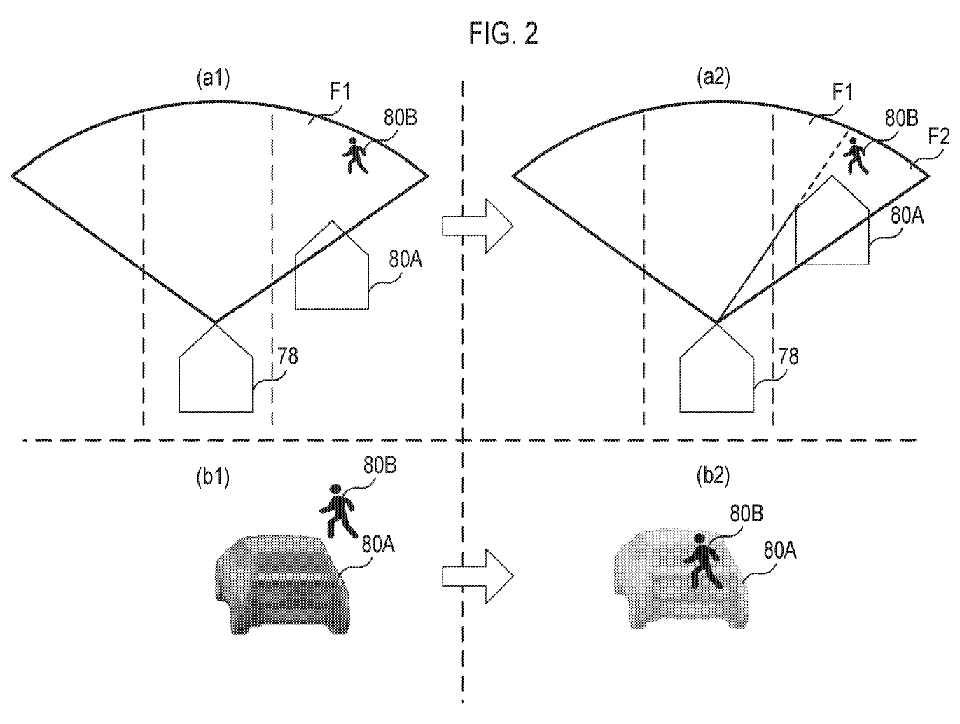

FIG. 2 is a schematic diagram showing a relationship between an object marker on a front side and an object marker on a back side in a detection range. (a1) and (a2) of FIG. 2 are diagrams schematically showing a detection example of the object marker. (b1) and (b2) of FIG. 2 are display examples of the detected object marker. In the following description using the drawings, an image corresponding to the object marker in a case of displaying the object marker is also described with the same reference numeral as the object marker in a case of detecting the object marker. Hereinafter, the description of the corresponding image may be omitted on the premise that the image corresponding to the object marker is displayed in a case of displaying the object marker, and the display of the object marker may be simply described as displaying the object marker. The detection in (a1) of FIG. 2 is a situation in which an object marker (80A) on a front side of a passenger vehicle is present on an adjacent lane within a detection range (F1) of a host vehicle 78 (camera device 24), and an object marker (80B) on a back side of a pedestrian is present behind the object marker (80A). In this case, since the object marker (80B) on the back side is also within the detection range and can be detected, as shown in (b1) of FIG. 2, a display unit displays images corresponding to the object marker (80A) on the front side and the object marker (80B) on the back side without being superimposed on each other. The detection in (a2) of FIG. 2 is a situation in which the object marker (80A) on the front side travels forward to become an obstacle, and the object marker (80B) on the back side is out of the detection range (F2). In such a case, the object marker (80A) on the back side that is out of the detection range (F2) disappears as an object marker and is not displayed in the related art. Therefore, in the present embodiment, in a case where it is estimated that the object marker (80B) on the back side is present overlapping the object marker (80A) on the front side, as shown in (b2) of FIG. 2, the object marker (80A) on the front side is made transparent, and the object marker (80B) on the back side is displayed by being virtually superimposed on the object marker (80A) on the front side.

In addition, the object marker estimation unit 64 refers to the status assigned to the object marker in estimating the superimposition state to discriminate between the object marker on the front side and the object marker on the back side. The display controller 66 performs display control in a case where the object marker on the back side disappears from the detection range.

A case of an object marker on a back side in a traveling direction intersecting the host vehicle, such as a pedestrian or a bicycle, will be described. The object marker estimation unit 64 estimates, in the assigned status, in a case where it is estimated that the object marker to be estimated is traveling in a direction intersecting a traveling direction of the host vehicle and disappears from the detection range in the vicinity of the object marker on the front side in accordance with the traveling, the superimposition state by using the object marker as the object marker on the back side. The display controller 66 displays, in a case where the object marker on the back side disappears from the detection range in accordance with the traveling in the superimposition state, an image corresponding to the object marker on the back side by virtually superimposing the image on the image corresponding to the object marker on the front side. Even in a case where there are a plurality of object markers on the back side, each of the objects to be estimated is discriminated. As described above, in the estimation of the superimposition state, the discrimination and the determination of the disappearance are performed in accordance with the traveling direction, and the estimation is performed including a transition from before the disappearance of the object marker on the back side from the detection range to the disappearance.

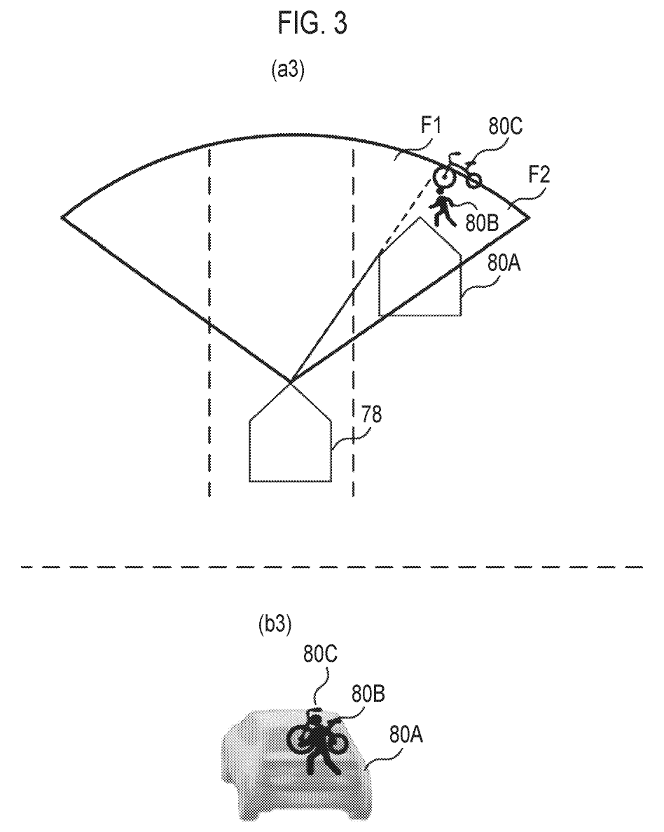

FIG. 3 is an example of a case where there are the object markers on the back side. The detection in (a3) of FIG. 3 is a detection in which there is an object marker (80A) on a front side of an ordinary vehicle, an object marker (80B) on a back side of a pedestrian is present behind the object marker (80A), and an object marker (80C) on a back side of a bicycle is present behind the object marker (80B). In this case, as shown in (b3) of FIG. 3, both the object markers (80B) and (80C) on the back side are displayed by being virtually superimposed on the object marker (80A) on the front side.

A case of an object marker on a back side in a front-rear traveling direction that is the same as a traveling direction of the host vehicle, such as an automatic motorcycle or an ordinary vehicle, will be described. The object marker estimation unit 64 estimates, in a case where it is estimated that an object marker present on an outer side of an object marker on an adjacent lane to a traveling lane of the host vehicle is traveling in a front-rear direction and disappears from the detection range in a vicinity of the object marker on the adjacent lane in the assigned status, the superimposition state by using the object marker on the adjacent lane as the object marker on the front side and using the object marker on the outer side as the object marker on the back side. The display controller 66 displays, in a case where the object marker on the back side disappears from the detection range in accordance with the traveling in the superimposition state, an image corresponding to the object marker on the back side by virtually superimposing the image on the image corresponding to the object marker on the front side.

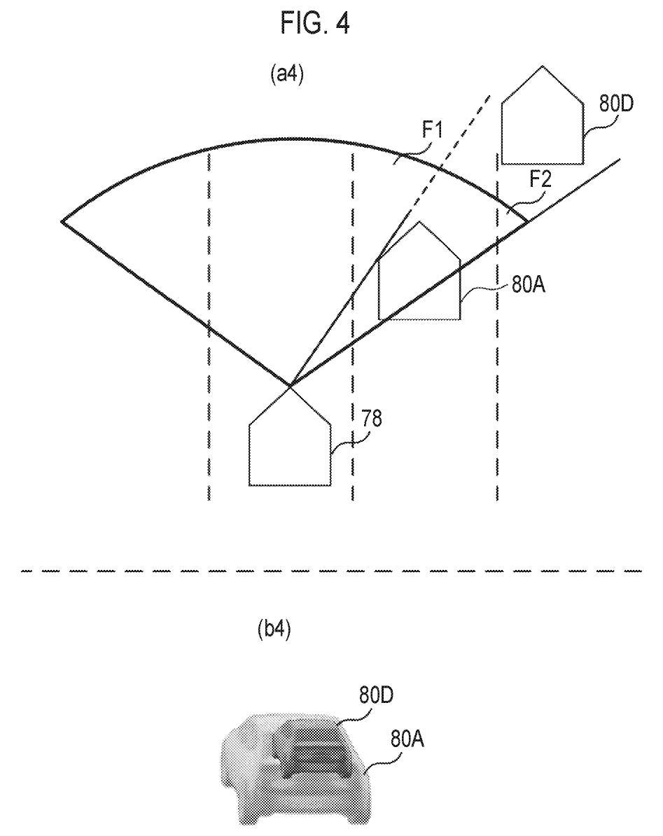

FIG. 4 is an example of a case where the object marker on the front side and the object marker on the back side have the same type of object marker of an ordinary vehicle. The detection in (a4) of FIG. 4 is a detection in which there is an object marker (80A) on a front side of an ordinary vehicle in an adjacent lane, and there is an object marker (80D) on a back side of the ordinary vehicle in a more adjacent lane. In this case, as shown in (b4) of FIG. 4, the object marker (80D) on the back side is displayed by being virtually superimposed on the object marker (80A) on the front side. In order to improve the visibility, the object marker (80D) on the back side may be displayed by changing a color arrangement or brightness of an edge part.

In addition, since the status includes the movement speed, a superimposition position on the object marker on the front side may be adjusted in accordance with the movement speed, and the object marker may be moved. The display controller 66 adjusts an initial position and a temporal position change as the superimposition position on the image corresponding to the object marker on the front side according to a movement speed before the estimated object marker on the back side disappears from the detection range.

### Flow of Control

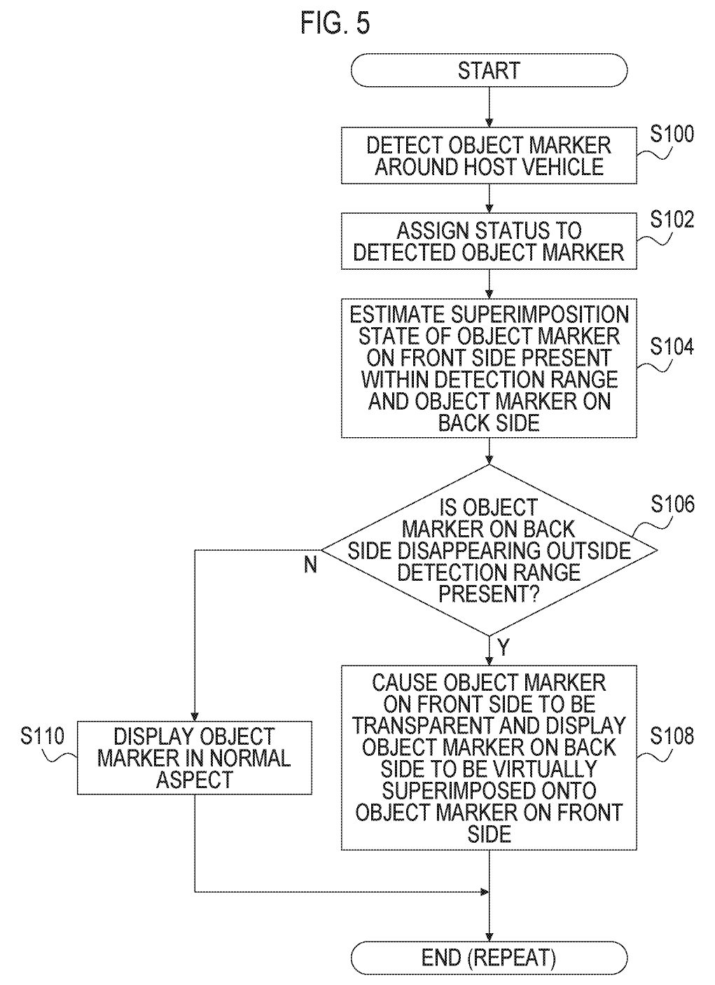

FIG. 5 is a flowchart for describing a flow of display control processing as a display control method executed by the display control ECU 42 according to the present embodiment. The display control processing is repeatedly executed in a predetermined cycle.

In S100, the object marker detection unit 62 detects an object marker around the host vehicle from the detection results of the radar device 22 and the camera device 24.

In S102, the object marker detection unit 62 assigns a status to the detected object marker.

In S104, the object marker estimation unit 64 estimates a superimposition state of the object marker on the front side present within the detection range and the object marker on the back side.

In S106, the object marker estimation unit 64 determines whether the object marker on the back side that deviates from the detection range and disappears outside the detection range is present. In a case where it is determined that the target is present, the processing proceeds to S108. In a case where it is determined that the target is not present, the processing proceeds to S110. In S110, the display controller 66 displays the detected object marker in a normal aspect. In a case where it is determined that the object marker is present, it is estimated that the object marker on the back side is present overlapping the object marker on the front side in the superimposition state.

In S108, in a case where it is estimated that the object marker on the back side is present overlapping the object marker on the front side in the superimposition state, the display controller 66 displays an image corresponding to the object marker on the back side by making an image corresponding to the object marker on the front side transparent and virtually superimposing the image corresponding to the object marker on the back side on the image corresponding to the object marker on the front side.

As described above, the display control ECU 42 according to the present embodiment can ensure the visibility in the display of the superimposed object markers.

### Second Embodiment

A second embodiment is an aspect in which the movement information is estimated in accordance with signal switching of a traffic light.

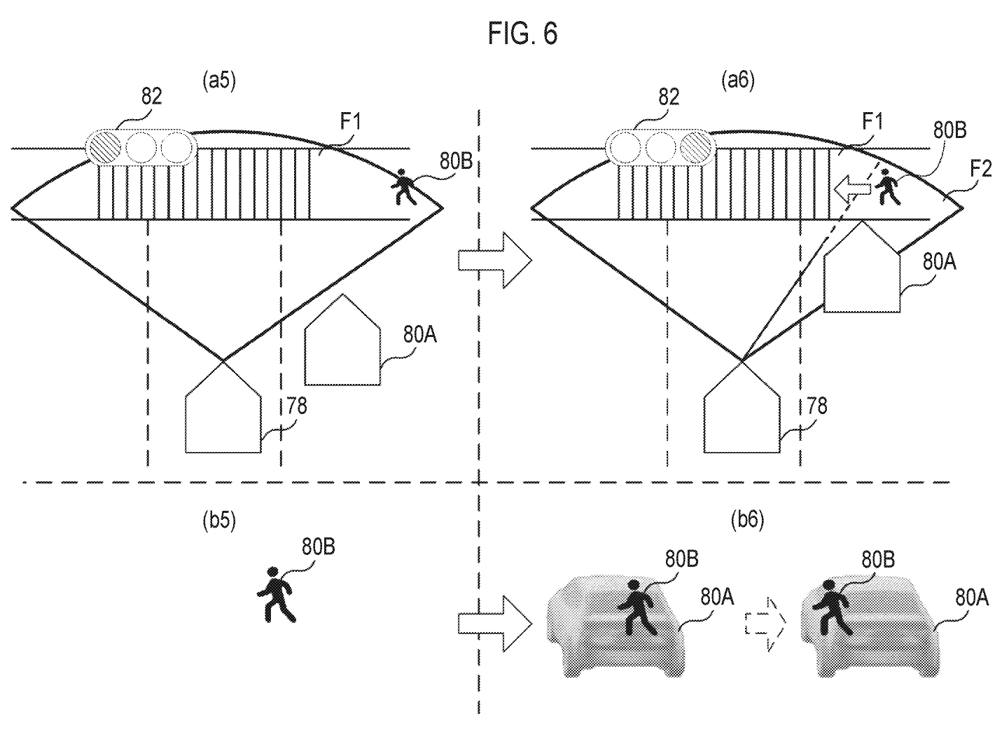

Processing of each unit of the second embodiment will be described. FIG. 6 is an example of detection and display of the object marker on the back side in a case where there is an intersection and a traffic light.

The object marker detection unit 62 further detects a traffic light at an intersection and signal switching of the traffic light. In (a5) of FIG. 6, a traffic light 82 and an object marker (80B) of a pedestrian are detected, and an ordinary vehicle behind an adjacent lane is out of the detection range and has not yet been detected as an object marker. In this case, solely the object marker (80B) of the pedestrian is displayed as in (b5) of FIG. 6. Next, the ordinary vehicle in the adjacent lane travels to a front of the intersection and enters a relationship with the object marker (80A) on the front side with respect to the pedestrian, and the object marker (80B) on the back side of the pedestrian disappears outside the detection range. As a result, the estimation of the superimposition state and the display are performed as in (b6) of FIG. 6, but the object marker (80B) on the back side is displayed by being moved in accordance with the signal switching. As the processing, the object marker estimation unit 64 estimates movement information including a movement start timing and a movement speed of the object marker on the back side in accordance with the signal switching of the traffic light at the intersection, for the object marker on the back side that has disappeared from the detection range at the intersection. The display controller 66 displays the object marker on the back side by moving the object marker in accordance with the estimated movement information.

As described above, the display control ECU 42 according to the second embodiment can reduce the sense of discomfort of the display of the object markers superimposed at the intersection.

In addition, in each of the embodiments, an aspect has been described in which the display control program 54 for causing the display control ECU 42 to function as the object marker detection unit 62, the object marker estimation unit 64, and the display controller 66 is stored (installed) in the storage 48 in advance. However, the display control program 54 can also be provided in a form of being recorded on a non-transitory recording medium such as an HDD, an SSD, or a DVD.

The flow of the processing described in each of the embodiments is an example, and needed steps may be deleted, new steps may be added, or the processing order may be changed within a range that does not deviate from the gist.

What is claimed is:

1. A display control device comprising:
an object marker detection unit configured to detect an object marker with a sensor that is predetermined, the sensor being provided in a host vehicle;
an object marker estimation unit configured to estimate a superimposition state of an object marker on a front side present in front of the host vehicle and within a detection range of the sensor and an object marker on a back side present behind the object marker on the front side; and
a display controller configured to, in a case where estimation is made that the object marker on the back side is present overlapping the object marker on the front side in the superimposition state, make an image corresponding to the object marker on the front side transparent and cause an image corresponding to the object marker on the back side to be displayed with the image corresponding to the object marker on the back side virtually superimposed onto the image corresponding to the object marker on the front side.

2. The display control device according to claim 1, wherein:
the object marker detection unit is configured to assign a status including a traveling direction of the detected object marker;
the object marker estimation unit is configured to estimate, in the assigned status, in a case where estimation is made that the object marker to be estimated is traveling in a direction intersecting a traveling direction of the host vehicle and disappears from the detection range in a vicinity of the object marker on the front side as the object marker to be estimated travels, the superimposition state by using the object marker to be estimated as the object marker on the back side; and
the display controller is configured to cause, in a case where the object marker on the back side in the superimposition state disappears from the detection range as the object marker on the back side travels, the image corresponding to the object marker on the back side to be displayed with the image corresponding to the object marker on the back side virtually superimposed onto the image corresponding to the object marker on the front side.

3. The display control device according to claim 1, wherein:
the object marker detection unit is configured to assign a status including a traveling direction and a lane of the detected object marker;
the object marker estimation unit is configured to estimate, in the assigned status, in a case where estimation is made that an object marker on an outer side of an object marker on an adjacent lane to a traveling lane of the host vehicle is traveling in a front-rear direction and disappears from the detection range in a vicinity of the object marker on the adjacent lane, the superimposition state by using the object marker on the adjacent lane as the object marker on the front side and using the object marker on the outer side as the object marker on the back side; and
the display controller is configured to cause, in a case where the object marker on the back side in the superimposition state disappears from the detection range as the object marker on the back side travels, the image corresponding to the object marker on the back side to be displayed with the image corresponding to the object marker on the back side virtually superimposed onto the image corresponding to the object marker on the front side.

4. The display control device according to claim 2, wherein:
the status includes a movement speed; and
the display controller is configured to adjust, in accordance with the movement speed before the estimated object marker on the back side disappears from the detection range, a superimposition position on the image corresponding to the object marker on the front side.

5. The display control device according to claim 1, wherein:
the object marker estimation unit is configured to estimate, for the object marker on the back side that has disappeared from the detection range at an intersection, movement information including a movement start timing and a movement speed of the object marker on the back side in accordance with signal switching of a traffic light at the intersection; and
the display controller is configured to cause the image corresponding to the object marker on the back side to be displayed by moving the image in accordance with the estimated movement information.
